(19) United States
(12) Patent Application Publication
(10) Pub. No.: US 2023/0342758 A1
(43) Pub. Date: Oct. 26, 2023

(54) CONTENT DISTRIBUTION VIA USAGE TRACKING NON-FUNGIBLE TOKENS

(71) Applicant: Bitvore Corp., Los Angeles, CA (US)

(72) Inventors: Greg Bolcer, Yorba Linda, CA (US); Alan Chaney, Simi Valley, CA (US)

(21) Appl. No.: 17/726,015

(22) Filed: Apr. 21, 2022

(51) Int. Cl. G06Q 20/36

(52) U.S. Cl. CPC G06Q 20/3678

(57) ABSTRACT

Usage tracking NFTs (UT-NFTs) provide a protocol and an exchange for scalable content distribution and tracking. The protocol provides programmable UT-NFTs that can link multiple layers of content. As the UT-NFTs are used, the content providers are paid via a cyptocurrency exchange. The exchange dictates and controls the dynamic pricing of content according to how instrumental the content is to the activities of the end user.

### BACKGROUND

Limitations and disadvantages of conventional methods and systems for content distribution will become apparent to one of skill in the art, through comparison of such approaches with some aspects of the present method and system set forth in the remainder of this disclosure with reference to the drawings.

### BRIEF SUMMARY

Methods and systems are provided for content distribution and tracking via Usage Tracking NFTs (UT-NFTs), substantially as illustrated by and/or described in connection with at least one of the figures, as set forth more completely in the claims.

### BRIEF DESCRIPTION OF THE DRAWINGS

FIG. 1 illustrates a first example system for content distribution and tracking via UT-NFTs in accordance with various example implementations of this disclosure.

FIG. 2 illustrates a second example system for content distribution and tracking via UT-NFTs in accordance with various example implementations of this disclosure.

FIG. 3 illustrates a first flowchart of an example method for content distribution and tracking via UT-NFTs in accordance with various example implementations of this disclosure.

FIG. 4 illustrates a second flowchart of an example method for content distribution and tracking via UT-NFTs in accordance with various example implementations of this disclosure.

FIG. 5 illustrates an example system for content generation via UT-NFTs in accordance with various example implementations of this disclosure.

FIG. 6 illustrates an example system for content distribution via UT-NFTs in accordance with various example implementations of this disclosure.

FIG. 7 illustrates an example system for content tracking via UT-NFTs in accordance with various example implementations of this disclosure.

### DETAILED DESCRIPTION

When purchasing content using traditional e-commerce today, the purchaser downloads the content and there is no tracking of the content once it is purchased. Digital Rights Management (DRM) techniques may include licensing agreements and encryption. However, DRM techniques can be circumvented, and the content provider is not compensated for usage after the initial download. Digital content, such as news, is typically monetized by advertisements. Currently, when a content provider wants to distribute and sell their content they go through a third party. For example, Bloomberg, LexisNexis and Thompson Reuters are third party distributers of financial information.

In various embodiments, the disclosed methods and systems dictate and control the dynamic pricing of content. The price for each piece of content may vary according to how instrumental the content is to the business activities of an end user. The price for a particular piece of content may dynamically and continually fluctuate accordingly to a score or other means of pricing the content. A particular piece of content (i.e., piece of business information in the case of the financial industry) may be scored according to its relevancy to the query and/or other qualities such as the number of intended users and/or the use case.

This disclosure is directed to methods and systems for decentralized content distribution and tracking using tokens and blockchains. In various embodiments, the methods and systems provide an automated, massively scalable, blockchain-based protocol and exchange for the purchasing of information/content from the content provider without involving a third-party middlemen.

A token is a cryptographically sound measure of value whose lifecycle is recorded on a decentralized registry as a blockchain where the creation, distribution, and destruction are controlled by a set of unchangeable and executable rules called a smart contract. The blockchains provide security and authentication for the exchange of content that may be used by a customer.

The cyptocurrency token is fungible/interchangeable and may be used for trading, borrowing and making payments. Smart contracts can be used to create smart property or tokenized assets that people can utilize in an ecosystem of exchange. ERC20, for example, is a standard used for creating and issuing smart contracts on the Ethereum blockchain. ERC stands for “Ethereum request for comment,” and the ERC20 standard was implemented in 2015. Cyptocurrency tokens are transferrable, trackable, inter-changeable for other items of value, and transaction based.

NFTs are used today for collectibles, phygital (tying to physical product/artifact) and access control/entry. NFTs are also standards based, transferrable and trackable. However, unlike cyptocurrency tokens, NFTs are programmable, globally unique, globally controlled and cannot be copied, substituted or sub-divided.

The disclosed methods and systems use two types of tokens. The first type of token is a specialized non-fungible tokens (NFTs), which will be referred to as a Usage Tracking NFT (UT-NFT). The second type of token is a cyptocurrency token that is used to compensate the content provider.

UT-NFTs grant access to containerized content and track the usage of the accessed content. By tracking usage, UT-NFTs create an audit trail for the compensation as well as a market for the cyptocurrency tokens themselves. Access granted by UT-NFTs can unlock software apps and data content. UT-NFTs can be programmed to change over time. UT-NFTs can refer to one or more layers of interconnected NFTs. The traceability of UT-NFTs provides cost leveling and time-shifting for content consumers. The network of UT-NFTs controls decentralized content that is monetized by attention, usage and results.

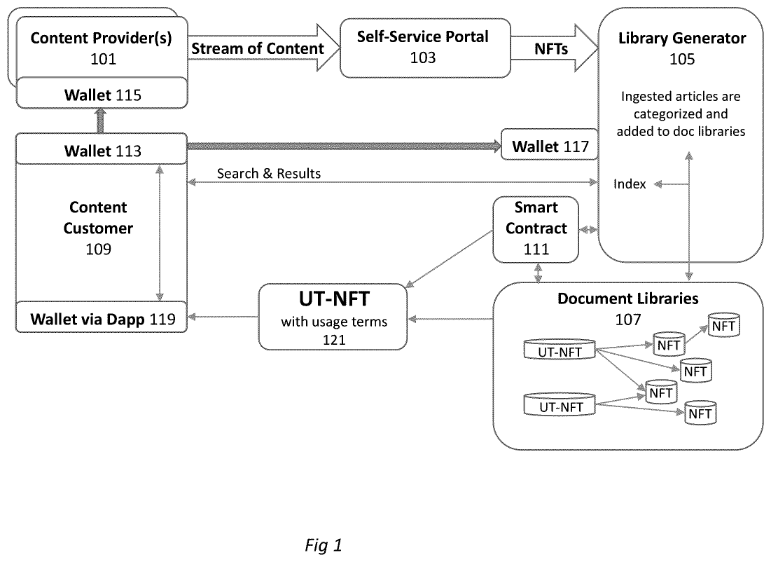

FIG. 1 illustrates a first example system for content distribution and tracking via UT-NFTs in accordance with various example implementations of this disclosure.

Content providers/publishers 101 can mint NFTs for individual articles of content. Minting is the creating of an NFT and all the steps for archiving, encrypting, storing, and making available the content in conjunction with the NFT usage. As illustrated, content providers 101 can create NFTs from a stream of content using a self-service portal 103. The function of self-service portal 103 may also be performed by other content processors.

The content providers 101 can stake their NFTs. Staking locks up an NFT for some period of time in exchange for the possibility of revenue as calculated by a value ranking algorithm in the library generator 105. Revenue and revenue splits may be determined from actual usage. The content providers 101 can stake an NFT (available for monetization) or unstake an NFT (making it no longer available, for example, after current licenses run out).

The library generator 105 mints UT-NFTs as collections of NFTs combined with other metadata. The UT-NFTs are stored in a document library 107. The UT-NFT may comprise metadata to indicate what is available within the UT-NFT. For example, metadata may comprise summaries, keywords, search indexes, word frequencies, word embeddings, encryption/decryption keys, access credentials, and pointers/links to the actual content. A word embedding may indicate such metrics as how often words follow each other, how close they appear, or what parts of speech they are. The pointers/links may indicate a container holding the content regardless of where it is located. Content may be in local file cache, cloud hosted, in an original site, etc.

A closed UT-NFT represents an exact set of records at the time the UT-NFT was minted as well as any derived metadata. An open UT-NFT represents an ongoing, constantly updated stream of content records that satisfy the initial query or search criteria. The query or search criteria can be any search index, keywords, extracted tags or feature such that subsequent records would fall under that query. UT-NFTs may be globally unique or limited to a predetermined number of copies, such that there can never be more than some number at use in the world.

UT-NFTs are programmable via pre-registered code, handlers, algorithms, and implementations that respond to an event in time to change the access to the UT-NFT. For example, an open UT-NFT may comprise a programmable hook that adds one or more NFTs to the UT-NFT as a means of updating the UT-NFT. Also, if a content provider/publisher 101 wants to retract their content from a UT-NFT due to not wanting it to be used in a certain way, a programmable UT-NFT hook could be used to remove an individual NFT or set of NFTs from the UT-NFT according to the licensing and ownership of a content customer 109. Programmable UT-NFT hooks may also work in reverse, where use of a particular NFT sends an event out to be captured as tracking information on the blockchain.

The UT-NFTs may be held in a blockchain (e.g., a private blockchain) due to the tracking and direct peer-to-peer interactions between the publishers 101 and the consumer 109. Only certain stakeholders/participants will be able to inspect the transactions. There may also be an additional restriction that publishers 101 only get to see tracking and history of things in which they participate and consumers 109 only get to see tracking and history of things they've licensed.

A decentralized app (Dapp) 119 is a web application that operates over a distributed and linked, peer-to-peer network of computers and that requires the installation of a web browser wallet plugin 113. The existence of a token or an NFT in the browser plugins's wallet 113 can be used in place of a username and password to grant capabilities of the Dapp 119. These capabilities can be anything from buying/selling assets in the wallet, showing a web display of all the assets in the wallet, creating summaries, staking, minting, bonding, sending assets, filtering and searching across them, etc.

The wallets 113, 115 and 117 may be browser plugin wallets like Metamask or Trust Wallet. Browser plugin wallets are useful for storing and allocating digital assets, such as cryptocurrency, as needed. For managing a larger numbers of things, such as numerous NFTs, cloud hosted private wallets with bulk management filters and tools through Dapp 119 may be used.

The InterPlanetary File System (IPFS) is a protocol and peer-to-peer network for storing and sharing data in a distributed file system. IPFS uses content-addressing to uniquely identify each file in a global namespace connecting all computing devices. Apache ORC (Optimized Row Columnar) is a free and open-source column-oriented data storage format.

IPFS (or equivalent) may be used to store the content. When a content NFT is staked, the NFT may be put into an Apache ORC container that generates all the metadata and encrypts any columns or pieces of the NFT that need to be protected. The ORC container is an efficient open source format that supports some tracking and protection. When the containers get delivered, they can be cached on the client consumer's machine for use by the machine learning notebooks.

A value rank or other means of organizing the content or associated NFTs may be given to an individual record based on an assessment of the record as applicable to either the topic of the record, i.e., a company, or the circumstances that make it financially relevant. Content publishers 101 can use this value rank or other means of organizing the content or associated NFTs to help determine the value of their content and/or expected revenue.

At the top level, a smart contract 111 is a programmatic implementation of the revenue split, such that if a collection of content is licensed, the flow of the revenue is programmatically determined with a smart contract. Smart contracts 111 are visible by both publishers 101 and consumers 109, and can be independently audited and verified by either the publishers 101 or consumers 109 by simulating various scenarios.

The content provider 101 (i.e., media owner or entity authorized to distribute media) securely distributes their content (e.g., data, information, etc.) to the end consumer 109 with secure tracking and proper authentication by leveraging NFTs. Each piece (or group) of content may have an associated NFT which has various properties including but not limited to a pointer that points to a location where that information resides on a separate server. The NFT itself may not contain actual content. Types of content may comprise, for example, financial support material and news content, a piece of art or digital frames of a film or animation.

The system may be used to arrange the licenses for machine learning directly from the news content providers or other content provider, or the owner of an asset of any kind such as a piece of art or a digital asset of another kind. Customers pay for content that is used for nonvisible machine learning purposes. In this example which is provided for illustration and not limitation, the news content provider(s) or other content providers 101 are able to put NFT into the network based on their articles. A library generator 105 aggregates the NFTs into UT-NFTs. A group of articles may be aggregated and put into a library 107 as a UT-NFT. The system can dynamically, on demand, generate UT-NFTs based on a search by a customer 109. For example, if the customer 109 only wants Tesla and Elon Musk content from a limited source, the library generator 105 can aggregate these NFTs into a collection and create a library UT-NFT.

For example, a customer 109 may use a machine learning notebook (a cloud computing instance set up for machine learning activities) to interact with a wallet via a Dapp web plugin 119. The wallet 119 will take in a UT-NFT 121 from the document library 107. The wallet 119 may access the UT-NFT 121 and cache it to a local machine as web cache. Some parts of that cache may be encrypted, so the UT-NFT 121 may actually provide the decryption keys. Provisioning of the decryption is checked with the wallet 119. If the wallet 119 confirms that an NFT associated with the UT-NFT 121 exists and is accessible, the access to content licensed via the NFT is recorded as a transaction on a blockchain (e.g., a private blockchain). The content owner 101 has the ability to see every time that their content is accessed. For the end user 109, this is a seamless process to access content and use an NFT. This allows tracking deeper into the use of content.

Behaviors inside the UT-NFT may be triggered according to programming. For example, if a publisher 101 generates multiple NFTs that are bundled into a UT-NFT, revenue/income in the form of tokens is made through a smart contract 111 comes back to the publisher 101. The publisher 101 may stake their NFTs (i.e., the NFTs are available for monetization) and unstake their NFTs (i.e., the NFT license is revoked) via programming. There is a life cycle of these NFTs using the programmable UT-NFTs.

The document library 107 allows the grouping of specific pieces of text information or other information, such as news articles, by source, by topic, by date range, etc., and once the entries have been added they cannot be removed (a fundamental feature of a blockchain). The inventory of NFTs within a UT-NFT may also be controlled by an NFT.

An example use of the system in FIG. 1 is for the monetization of financial support material. A company typically maintains their own financial support material. This financial support material may be publically disclosed in an SEC filing. Today, a third party may extract this material out of the SEC filing and provide the extracted content for a fee, which is not shared with the original company. However, with the disclosed system, the company may also directly provide their own financial support material for monetization at the same time as they file it with the SEC.

Once a UT-NFT is purchased, some number of UT-NFTs are granted to individual wallets 205. Each individual user 109 then may access that content. The user transfers the UT-NFT 121 to their wallet, such as a Metamask wallet, TrustWallet or other wallet) 119. The user launches the machine learning notebook of their choice integrated with a cryptocurrency wallet 113. The cryptocurrency wallet 113 detects what NFTs are available and allows a summary of what the user is using in their activities—various queries, what source, how many, records with these keywords, etc. The user executes a query on the data they need or want from the UT-NFT. A wallet 117 associated with the library generator 105 verifies the access and records that are then used on a blockchain (e.g., a private blockchain) for tracking. When content is used, the user downloads it from the IPFS system or other system using the access credentials in the UT-NFT. The user downloads the ORC container or other container into a local cache. When the full content is accessed, the software calls the NFT, gets the decryption key from the UT-NFT, and decrypts the local columns in the ORC container or other container such that any content, tags, values, etc. can be used within the notebook.

The blockchain records all uses of the individual NFTs as well as the encompassing UT-NFT by the notebook/content user. If a user no longer has the NFT in their wallet or the NFT expired and can't be renewed, cache checking will not allow access to, by way of example and not limitation, the IPFS and encrypt the whole local ORC record in the cache, remove it from the cache, or mark it for removal from the cache after some period of time.

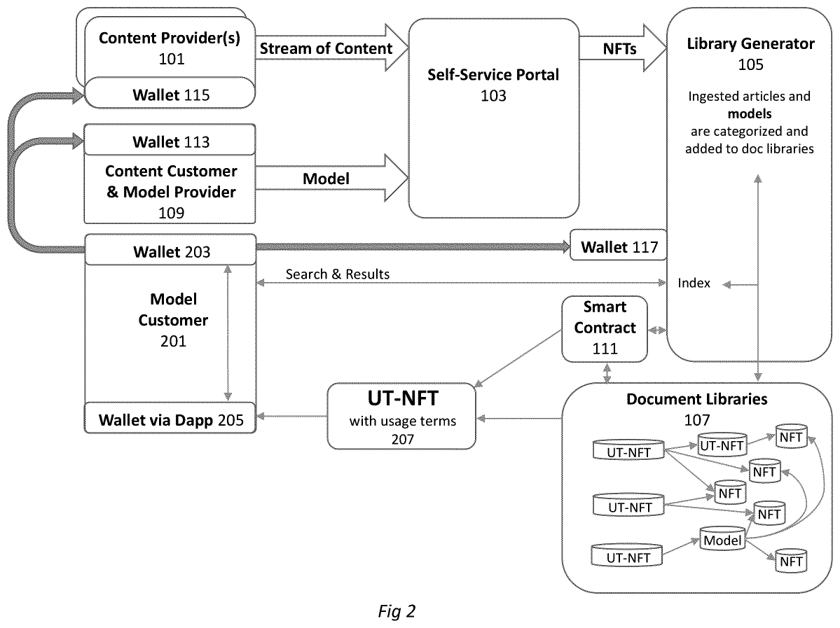

FIG. 2 illustrates a second example system for content distribution and tracking via UT-NFTs in accordance with various example implementations of this disclosure.

The customer 109 may license a UT-NFT to create a machine learning model. If the customer 109 wishes to license their machine learning model, they can become a model provider and put the model back into the network via the disclosed protocol as a piece of content itself. An NFT for the model, as a piece of content, represents the model and a license to the model is controlled and allocated by using this NFT in the system/protocol described in this disclosure. This NFT may be generated by the self-service portal 103. The library generator 105 stakes a UT-NFT 207 with the model NFT and all of the content NFTs that are used by the model NFT.

A model customer 201 has their own wallet 205 on their local machine. When the model customer 201 receives the UT-NFT 207 in their wallet 205, the UT-NFT 207 gives the model customer 201 the right to use the model contained in the model NFT and all of the content required by the model which may be contained in the model NFT or another location. The UT-NFT 207 could be delivered in a container. The container may have portions encrypted or may be completely encrypted. The container could be loaded to a local machine or cached for access to all or part of it. How often the wallet 205 is checked for the NFTs may be tracked.

Consumers for the machine learning protocol 201 may also require the browser plugin wallet 205 to allow for tracking, unlocking and caching of the content containers, and integration with the notebooks using the content. The notebook may comprise machine learning notebook software running with a browser and a development environment. A commonly used machine learning notebook environment is the Jupyter notebook. The Jupyter notebook is a Python programming language notebook that has thousands of machine learning and coding libraries. Integration allows the notebooks to interact with the Web's crypto wallet plugin 203 to determine which NFTs grant access to which data containers.

When the model customer 201 uses a licensed model and associated content, revenue flows back to the wallet 113 of the model provider 109 and to the wallet 115 of the original content provider 101. Transitory multiple layers of smart contracts may be added to a UT-NFT, such that attribution falls back to people, such as content providers or asset owners, including owners of a piece of art, etc., actually responsible for various aspects.

A model builder/provider 109 may use, for example, ten different sources and a million different articles. If the model builder 109 decides that a hundred thousand of those articles are really important for a model, the model builder 109 can take that set of hundred thousand articles or other pieces of information or content and his model and put them both back into the system. This selection changes the attribution and importance of each of the articles or other pieces of content. Whoever helped provide the content for that model can be properly compensated in the system.

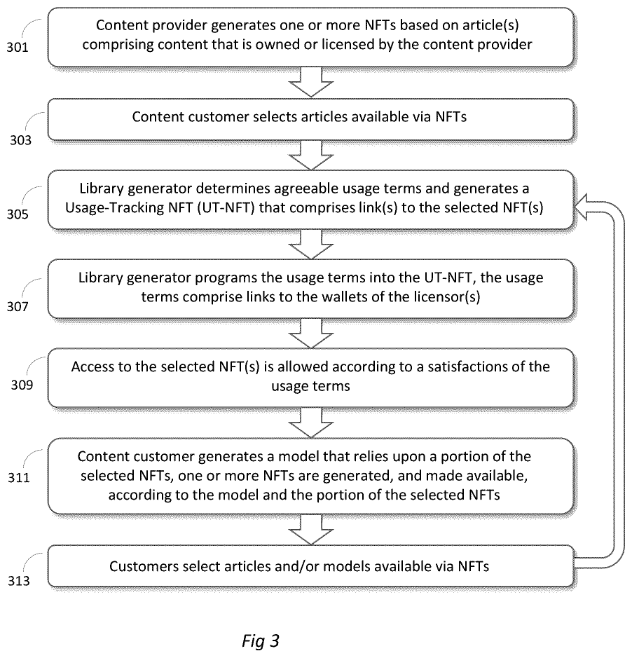

FIG. 3 illustrates a first flowchart of an example method for content distribution and tracking via UT-NFTs in accordance with various example implementations of this disclosure.

At 301, a content provider generates one or more NFTs based on one or more articles that comprise content owned or licensed by the content provider.

At 303, a content customer selects articles available via NFTs.

At 305, a library generator determines agreeable usage reports and generates a Usage-Tracking NFT (UT-NFT) that comprises one or more links to the selected NFTs. One or more computers generate the UT-NFT according to one or more digital items from one or more licensors.

At 307, the library generator programs the usage reports into the UT-NFT. The usage reports comprise links to the wallets of the licensors. The one or more computers dynamically generate a relevancy score or other score or other means of organizing the information/data, usage reports and a license fee for the UT-NFT. The relevancy score or other score may be determined according to how often the one or more digital items are accessed by one or more preexisting customers or it may be determined by some other method. The relevancy score or other score may also be determined according to an estimate of how often the one or more digital items are expected be accessed in the future or the score may be determined by another method. The relevancy score or other score and the usage reports are used to determine the license fee.

The license fee may be determined according to the relevancy score or other score and the usage reports or some other method. The usage reports may comprise one or more of: who can access the one or more digital items, what device can access the one or more digital items, where the one or more digital items can be accessed, how many times the one or more digital items can be accessed, and why the one or more digital items are being accessed.

The license fee may be paid via a cryptocurrency or other token or means of transaction. When the license fee is paid to more than one licensor, each of the licensors is paid according a predetermined share of the license fee.

At 309, access to the selected NFTs is allowed according to a satisfaction of the usage reports. Access to the selected NFTs may be authenticated via a virtual wallet of the library generator. A payment handshake is recorded in a blockchain. This blockchain or other blockchain may be reviewed by the library generator when the relevancy score or other score is determined. The virtual wallet may also receive cryptocurrency or token or other form of transaction according to the usage reports.

The library generator maintains a record of details associated with any access to the one or more digital items via the UT-NFT. The one or more digital items comprise articles, financial information or other information or content, and/or models that use a digital item.

At 311, a content customer generates a model that relies upon a portion of the selected NFTs. One or more NFTs are generated, and made available, according to the model and the portion of the selected NFTs.

At 313, additional customers select articles or other information or content and/or models available via NFTs. A different UT-NFT may be generated according to news articles or other information and an AI model that uses those news articles or other information.

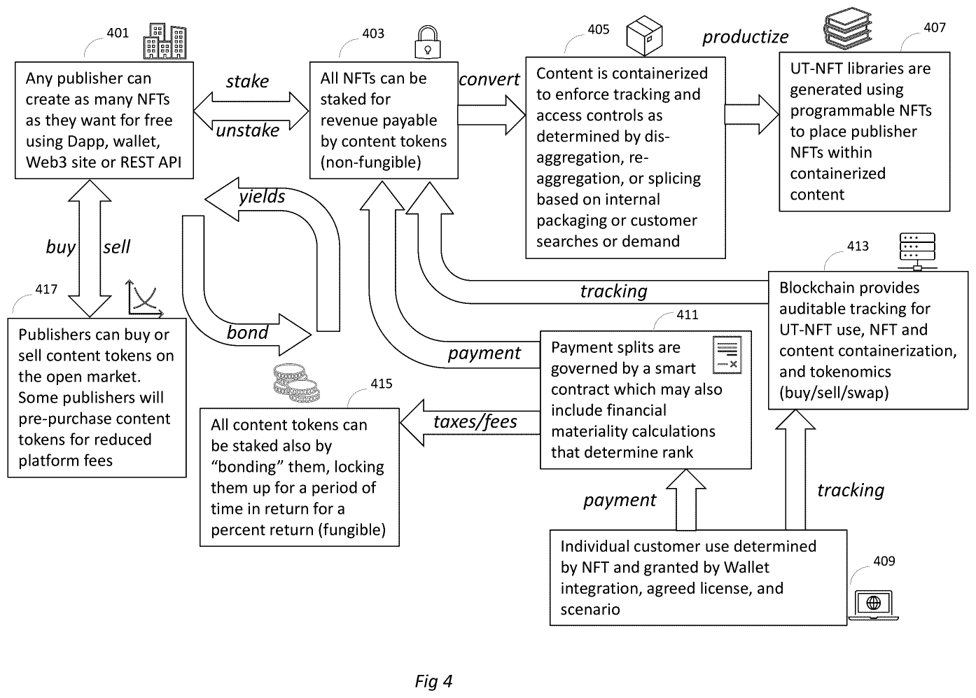

FIG. 4 illustrates a second flowchart of an example method for content distribution and tracking via UT-NFTs in accordance with various example implementations of this disclosure.

At 401, any publisher can create as many NFTs as they want for free using Dapp, wallet, Web3 site or REST API.

At 403, all of the publisher NFTs can be staked for revenue payable by content tokens (non-fungible) or other means of transacting.

At 405, content is containerized to enforce tracking and access controls as determined by dis-aggregation, re-aggregation, or splicing based on internal packaging or customer searches or demand.

At 407, UT-NFT libraries are generated using programmable NFTs or other NFTs to containerize publisher NFTs or other NFTs. Publisher NFTs or other NFTs may be containerized within one or more layers of containers.

At 409, an individual customer's use is determined by an NFT and granted by a wallet integration, agreed license, and scenario.

At 411, payment splits are governed by a smart contract which may also include financial materiality calculations or other calculations that determine rank or some other means of organizing the content and/or associated NFTs.

At 413, a blockchain provides auditable tracking for UT-NFT use, NFT and content containerization, and tokenomics (i.e., buying, selling and swapping tokens).

At 415, some content tokens or other tokens may be staked by “bonding” them. Bonded fungible NFTs are locked up for a period of time in return for a certain percentage return or rate of interest charged or other means of compensation.

At 417, publishers can buy or sell content tokens on the open market. Some publishers will pre-purchase content tokens for reduced platform fees or other reason.

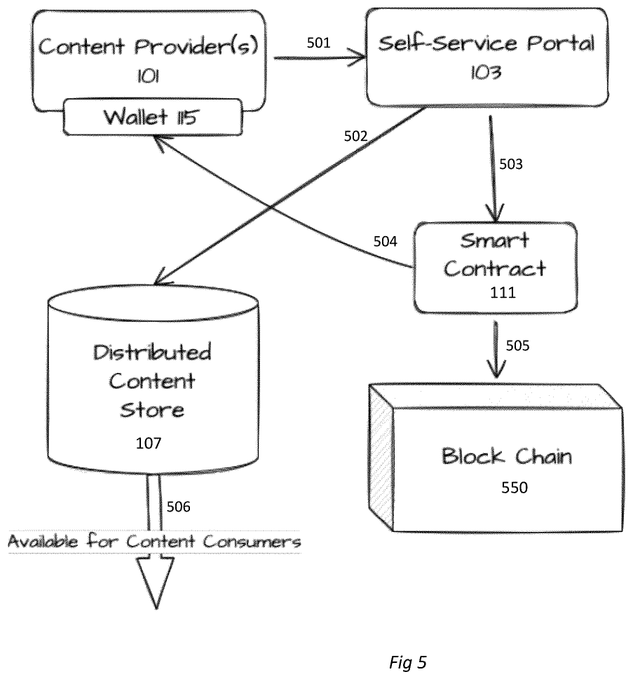

FIG. 5 illustrates an example system for content generation via UT-NFTs in accordance with various example implementations of this disclosure.

At 501, content providers/publishers 101 can mint NFTs for individual articles of content using a self-service portal 103 or any other type of content processor. At 502, groups of NFTs are combined together and stored as UT-NFTs in a distributed content store (e.g., document library) 107. At 503, a smart contract 111 of the UT-NFTs may be held in a blockchain (e.g., a private blockchain) 501. At 504, the smart contract 111 of the UT-NFTs may also be held in a wallet 115 of the content providers/publishers 101. At 505, the smart contract 111 of the UT-NFTs is maintained in a block chain 550. At 506, the UT-NFTs in the distributed content store/library 107 are available for content consumers.

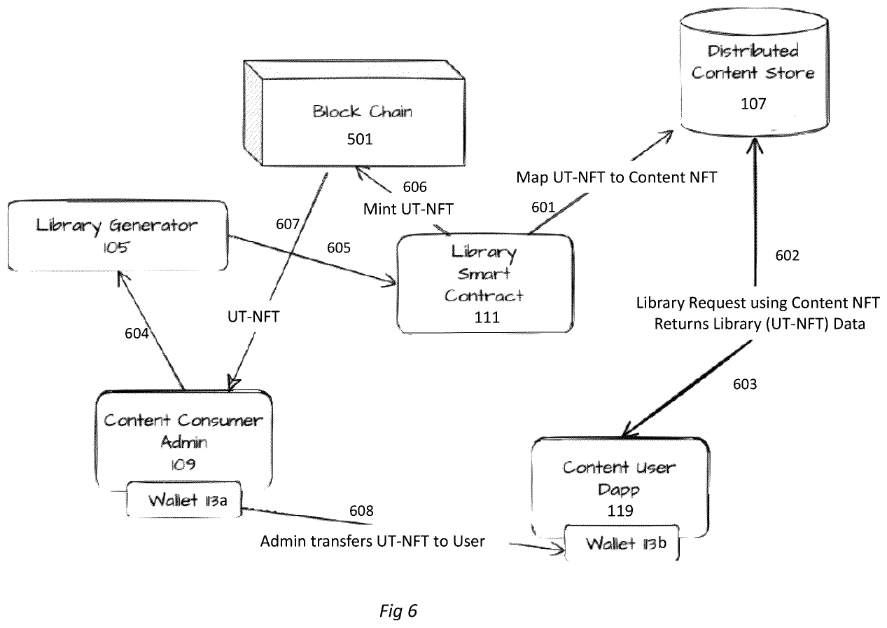

FIG. 6 illustrates an example system for content distribution via UT-NFTs in accordance with various example implementations of this disclosure.

At 601, the smart contract 111 of the UT-NFTs maps the UT-NFT to the embedded content NFT. This index/mapping is available to the content user via the distributed content store/library 107. At 602, the content user makes a request, from the distributed content store/library 107 based on the mapped content NFTs. At 603, the distributed content store/library 107 returns UT-NFT data to the content user Dapp 119. At 604, the content consumer admin 109 requests a UT-NFT from a library generator 105. At 605, the library generator 105 updates the smart contract 111 based on the content consumer admin 109 request. At 606, the updated smart contract 111 is added to the block chain 501 when the UT-NFT is minted for the content consumer admin 109. At 607, the newly minted UT-NFT is transferred to the wallet 113a of the content consumer admin 109. At 608, the newly minted UT-NFT is transferred from the wallet 113a of the content consumer admin 109 to the wallet 113b of the user.

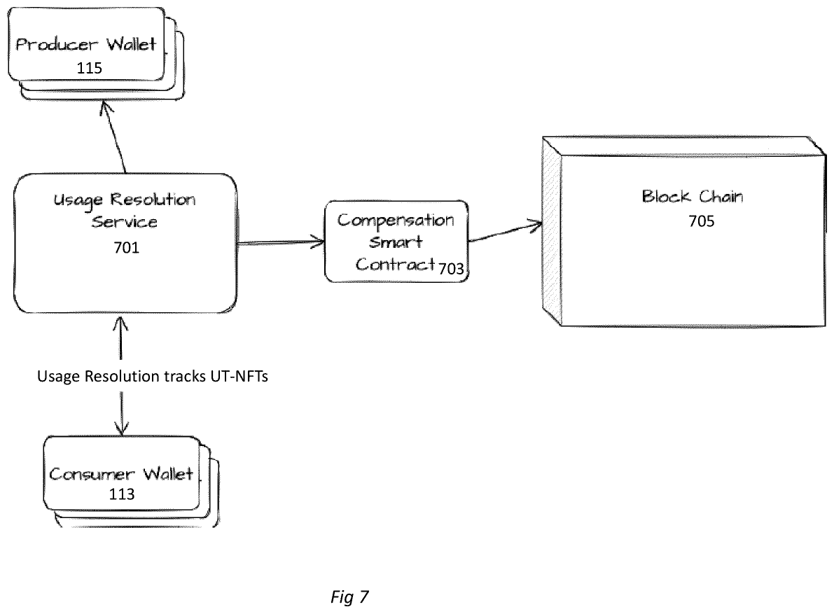

FIG. 7 illustrates an example system for content tracking via UT-NFTs in accordance with various example implementations of this disclosure.

Once a UT-NFT is purchased, a usage resolution service 701 resolves the UT-NFTs (from the distributed content store/library 107) into transactions with content NFTs. The usage resolution service 701 tracks the UT-NFTs in consumer wallets 113 as well as the NFTs minted from the producers wallets 115. The compensation smart contracts 703 are generated and updated according to the resolutions determined by the usage resolution service 701. A block chain 705 maintains the record of stacked content NFTs and the UT-NFTs.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system comprising:
a library generator configured to generate a usage-tracking, non-fungible token (UT-NFT) according to one or more digital items from one or more licensors; and
a contract generator configured to dynamically generate, for the UT-NFT, a relevancy score, usage reports and a license fee, wherein the contract generator is configured to program the usage reports into the UT-NFT.

2. The system of claim 1, wherein:
the system comprises a wallet associated with the library generator, and
the wallet is configured to record details associated with an access to the one or more digital items via the UT-NFT.

3. The system of claim 1, wherein:
the one or more digital items comprise one or more pieces of information and at least one additional digital item, and
the library generator is configured to generate a different UT-NFT according to a subset of the one or more pieces of information and the at least one additional digital item.

4. The system of claim 1, wherein:
the at least one digital item comprises an artificial intelligence (AI) model that uses one or more pieces of information.

5. The system of claim 1, wherein:
the system comprises a self-service portal configured to generate one or more non-fungible tokens (NFTs) according to the one or more pieces of information, and
the library generator is configured to generate the UT-NFT according to the one or more NFTs.

6. The system of claim 1, wherein:
the library generator is operable to generate and store a plurality of UT-NFTs according to a plurality of articles, and
the one or more digital items are selected, from among the plurality of articles, by a customer.

7. The system of claim 1, wherein:
the usage reports specify a wallet of at least one of the one or more licensors.

8. The system of claim 1, wherein:
the dynamically generated relevancy score is derived according to:
how often the one or more digital items have been accessed, and/or
how often the one or more digital items are expected to be accessed in the future.

9. The system of claim 1, wherein:
the license fee is determined according to the relevancy score and the usage reports, wherein
the usage reports comprise one or more of:
who can access the one or more digital items,
what device can access the one or more digital items,
where the one or more digital items can be accessed,
when the one or more digital items can be accessed,
how many times the one or more digital items can be accessed, and
why the one or more digital items are being accessed.

10. The system of claim 1, wherein:
a license fee is paid, via a cryptocurrency, to the one or more licensors, wherein each of the one or more licensors are paid according a predetermined share of the license fee.

11. A method implemented via one or more computers, comprising:
generating a usage-tracking, non-fungible token (UT-NFT) according to one or more digital items from one or more licensors;
dynamically generating, for the UT-NFT, a relevancy score, usage reports and a license fee; and
programming the usage reports into the UT-NFT.

12. The method of claim 11, wherein the method comprises:
maintaining a record of details associated with an access to the one or more digital items via the UT-NFT.

13. The method of claim 11, wherein:
the one or more digital items comprise one or more articles and at least one additional digital item, and
the method comprises generating a different UT-NFT according to a subset of the one or more articles and the at least one additional digital item.

14. The method of claim 11, wherein:
the at least one digital item comprises an artificial intelligence (AI) model that uses one or more articles.

15. The method of claim 11, wherein the method comprises:
generating one or more non-fungible tokens (NFTs) according to the one or more articles, and
generating the UT-NFT according to the one or more NFTs.

16. The method of claim 11, wherein:
the one or more digital items are selected, from among a plurality of digital items, by a customer.

17. The method of claim 11, wherein:
the usage reports specify a wallet of at least one of the one or more licensors.

18. The method of claim 11, wherein the method comprises:
deriving the relevancy score according to:
how often the one or more digital items have been accessed, and/or
how often the one or more digital items are expected to be accessed in the future.

19. The method of claim 11, wherein the method comprises:
determining the license fee according to the relevancy score and the usage reports, wherein the usage reports comprise one or more of:
who can access the one or more digital items,
what device can access the one or more digital items,
where the one or more digital items can be accessed,
when the one or more digital items can be accessed,
how many times the one or more digital items can be accessed, and
why the one or more digital items are being accessed.

20. The method of claim 11, wherein the method comprises:
requiring the license fee to be paid, via a cryptocurrency, to the one or more licensors, wherein each of the one or more licensors are paid according a predetermined share of the license fee.
